(19) United States
(12) Patent Application Publication
(10) Pub. No.: US 2014/0043567 A1
(43) Pub. Date: Feb. 13, 2014

(54) BLUE PHASE LIQUID CRYSTAL DISPLAY PANEL AND ELECTRODE MANUFACTURING METHOD THEREOF

(71) Applicant: InnoLux Corporation, Miao-Li County (TW)

(72) Inventors: Chien-Hung CHEN, Miao-Li County (TW); Yu-Wei CHEN, Miao-Li County (TW); Chuan-Chung WANG, Miao-Li County (TW); Pi-Ying CHUANG, Miao-Li County (TW)

(73) Assignee: InnoLux Corporation, Miao-Li County (TW)

(21) Appl. No.: 13/948,716

(22) Filed: Jul. 23, 2013

(30) Foreign Application Priority Data
Aug. 10, 2012 (TW) 101129065

(51) Int. Cl. G02F 1/1343; G02F 1/1335; G02F 1/1333

(52) U.S. Cl. CPC G02F 1/1343; G02F 1/1333; G02F 1/133345; G02F 1/133528
USPC 349/96; 349/160; 349/138; 349/139; 427/58

(57) ABSTRACT

A blue phase liquid crystal (BPLC) display panel includes a first substrate, a second substrate, a protrusion, a BPLC, and a driving electrode. The protrusion is disposed on the first substrate. The BPLC is disposed between the first and second substrates. The driving electrode covers the protrusion. A vertical distance from the protrusion's bottom to one end portion of the driving electrode is larger than zero and less than or equal to four fifths of a height of the protrusion. Thereby, the production yield of the BPLC display panel can be increased.

### CROSS REFERENCE TO RELATED APPLICATIONS

This Non-provisional application claims priority under 35 U.S.C. §119(a) on Patent Application No(s). 101129065 filed in Taiwan, Republic of China on Aug. 10, 2012, the entire contents of which are hereby incorporated by reference.

### BACKGROUND

1. Technical Field

The disclosed embodiments relate to a liquid crystal display panel and an electrode manufacturing method thereof and, in particular, to a blue phase liquid crystal display panel and an electrode manufacturing method thereof.

2. Related Art

The blue phase liquid crystal (BPLC) is a self-assembly three-dimensional photonic crystal structure, existing between the isotropic phase and the cholesteric phase. The BPLC has a self-assembly 3D crystalline characteristic, but also shows a liquid property. Besides, the lattice parameter of the BPLC is easily changeable so that it becomes an excellent tunable photonic crystal with various electro-optical properties.

It is found in the BPLC display panel that disposing a driving electrode on the protrusion will cause the transmittance to be increased. However, in the conventional electrode manufacturing method, the driving electrode is easy to be broken or remain somewhere undesired for the sake of the height of the protrusion so that the production yield is decreased.

Therefore, it is an important subject to provide a BPLC display panel and an electrode manufacturing method thereof that can cause the production yield to be increased a lot.

### SUMMARY

In view of the foregoing subject, an objective of the invention is to provide a BPLC display panel and an electrode manufacturing method thereof that can cause the production yield to be increased a lot.

To achieve the above objective, a blue phase liquid crystal (BPLC) display panel according to the embodiments of the invention comprises a first substrate, a second substrate, a protrusion, a BPLC, and a driving electrode. The protrusion is disposed on the first substrate. The BPLC is disposed between the first and second substrates. The driving electrode covers the protrusion. A vertical distance from one end portion of the driving electrode to a bottom of the protrusion is larger than zero, and less than or equal to four fifths of a height of the protrusion.

In one embodiment, the vertical distance is greater than or equal to one fifth of the height of the protrusion.

In one embodiment, a horizontal distance of two end portions of the driving electrode is less than or equal to a width of the bottom of the protrusion, and greater than or equal to a half of the width.

In one embodiment, the first substrate is a top substrate or a bottom substrate of the BPLC display panel.

In one embodiment, the form of the protrusion includes a flat surface, a curviform surface, a polygon, or their any combination.

In one embodiment, the driving electrode is a pixel electrode, a common electrode, or the combination of pixel electrodes and common electrodes.

In one embodiment, the BPLC display panel further comprises a protrusion disposed on the second substrate and a driving electrode covering the protrusion of the second substrate.

In one embodiment, the driving electrodes disposed on both of the first and second substrates are the combination of a pixel electrode and a common electrode.

In one embodiment, the BPLC display panel further comprises another driving electrode disposed on the first substrate. The BPLC display panel further comprises an insulating layer disposed between the another driving electrode and the driving electrodes.

In one embodiment, shape of the protrusions is bar-shaped, jagged, grid-shaped, and pectinate.

In one embodiment, the BPLC display panel further comprises a first polarizing element and a second polarizing element. The first polarizing element is disposed on the first substrate, and the second polarizing element is disposed on the second substrate.

To achieve the above objective, a blue phase liquid crystal (BPLC) display panel according to the embodiments of the invention comprises a first substrate, a second substrate, a protrusion, a BPLC, and a driving electrode. The protrusion is disposed on the first substrate. The BPLC is disposed between the first and second substrates. The driving electrode covers the protrusion. A horizontal distance of two end portions of the driving electrode is less than or equal to a width of a bottom of the protrusion, and greater than or equal to a half of the width.

To achieve the above objective, an electrode manufacturing method of a blue phase liquid crystal (BPLC) display panel according to the embodiments of the invention comprises steps of: forming a plurality of protrusions on a substrate; forming a first patterned photoresist layer covering the protrusions and the substrate and exposing a part of each of the protrusions; forming a driving electrode layer covering the first patterned photoresist layer and the protrusions; forming a second patterned photoresist layer covering the driving electrode layer and exposing at least an electrode exposing portion of the driving electrode layer located between the protrusions; removing the electrode exposing portion; removing the second patterned photoresist layer; and removing the first patterned photoresist layer for defining a plurality of driving electrodes from the driving electrode layer.

In one embodiment, the first patterned photoresist layer and the second patterned photoresist layer are both positive photoresist or negative photoresist.

In one embodiment, the first patterned photoresist layer and the second patterned photoresist layer are the combination of positive photoresist and negative photoresist.

In one embodiment, the driving electrodes are pixel electrodes, common electrodes, or the combination of pixel electrodes and common electrodes.

In one embodiment, the exposed part of the protrusions is a top portion of the protrusion.

As mentioned above, in the BPLC display panel and the electrode manufacturing method thereof according to the embodiments of the invention, a first patterned photoresist layer is first formed to cover a part of the protrusions and the substrate so that the peak-to-valley height of the protrusion is reduced when the photoresist layer is disposed thereon. Thereby, the second patterned photoresist layer can be formed more uniformly and accurately, and therefore the second patterned photoresist layer will not remain at the electrode exposing portion so that the electrode exposing portion can be removed completely and accurately. Besides, the second patterned photoresist layer can completely and accurately cover the top portion of the protrusion to protect the driving electrode on the top portion of the protrusion from being removed in the step of removing the electrode exposing portion, for maintaining the completeness of the electrical conductivity. Therefore, the BPLC display panel and the electrode manufacturing method thereof according to the embodiments of the invention can increase the production yield a lot.

### BRIEF DESCRIPTION OF THE DRAWINGS

The invention will become more fully understood from the detailed description and accompanying drawings, which are given for illustration only, and thus are not limitative of the present invention, and wherein:

FIG. 1 is a flow chart of an electrode manufacturing method of a blue phase liquid crystal (BPLC) display panel according to an embodiment of the invention;

FIGS. 2A to 2I are schematic diagrams showing the electrode manufacturing method of a BPLC display panel according to the first embodiment of the invention;

FIGS. 3A to 3I are schematic diagrams showing the electrode manufacturing method of a BPLC display panel according to the second embodiment of the invention;

FIGS. 4A to 4C are enlarged diagrams schematically showing some variations of the protrusion and the corresponding driving electrode thereon according to an embodiment of the invention;

FIGS. 5A to 5D are schematic diagrams of some variations of the protrusion in a top view according to an embodiment of the invention; and

FIGS. 6 to 9 are schematic diagrams of some variations of the BPLC display panel according to an embodiment of the invention.

### DETAILED DESCRIPTION

The present invention will be apparent from the following detailed description, which proceeds with reference to the accompanying drawings, wherein the same references relate to the same elements.

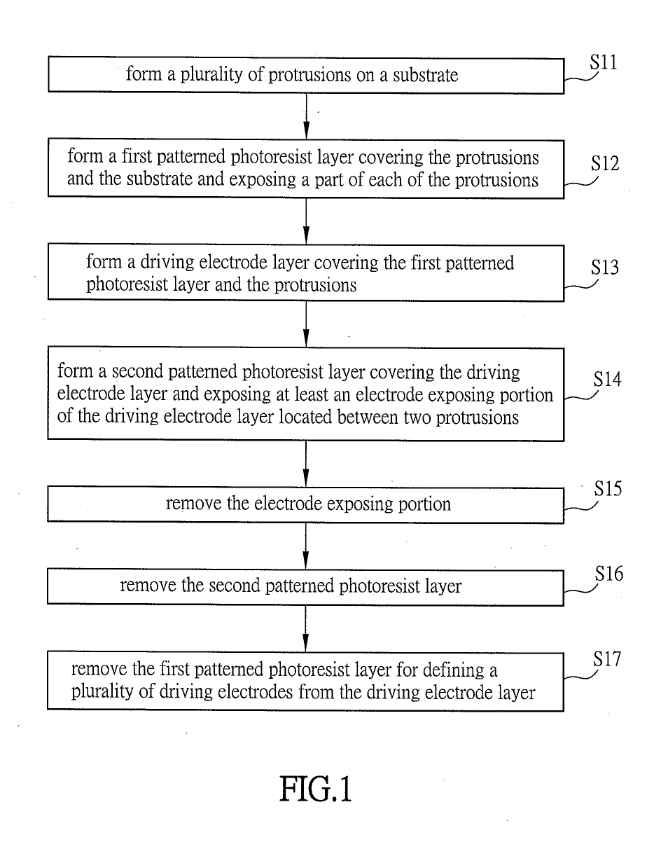

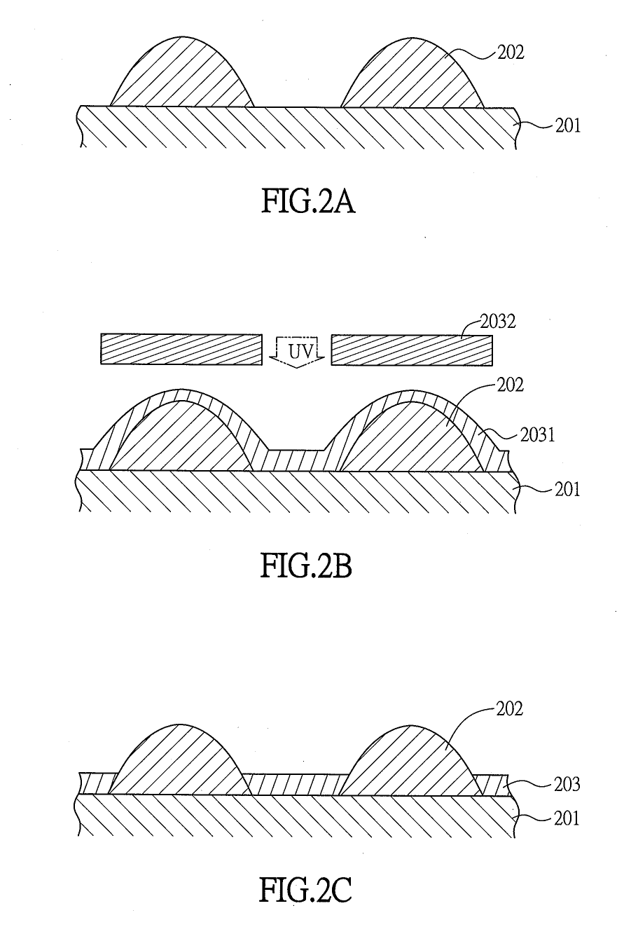

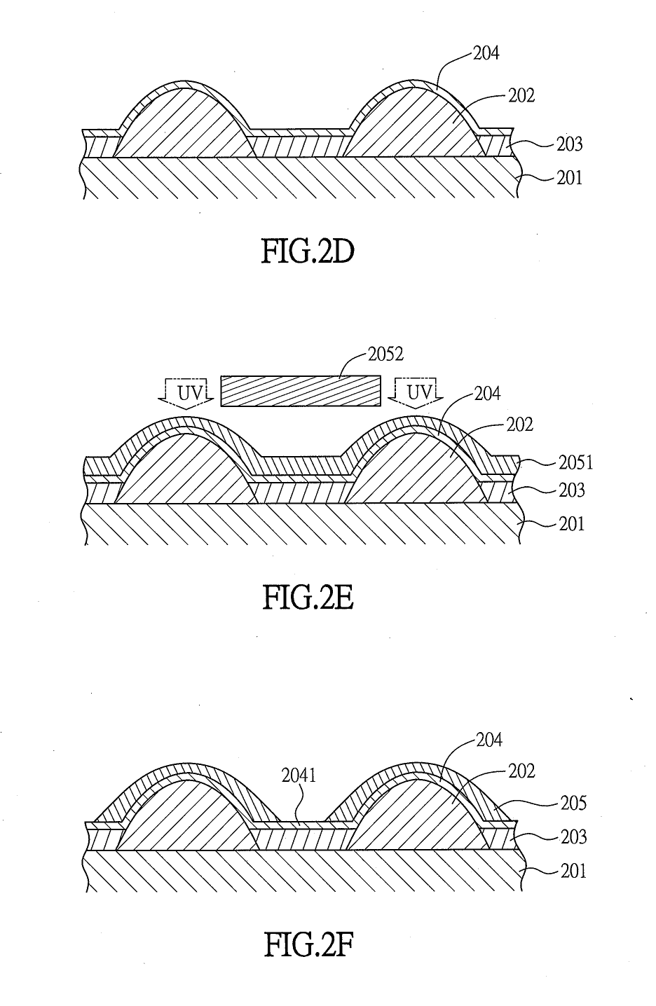

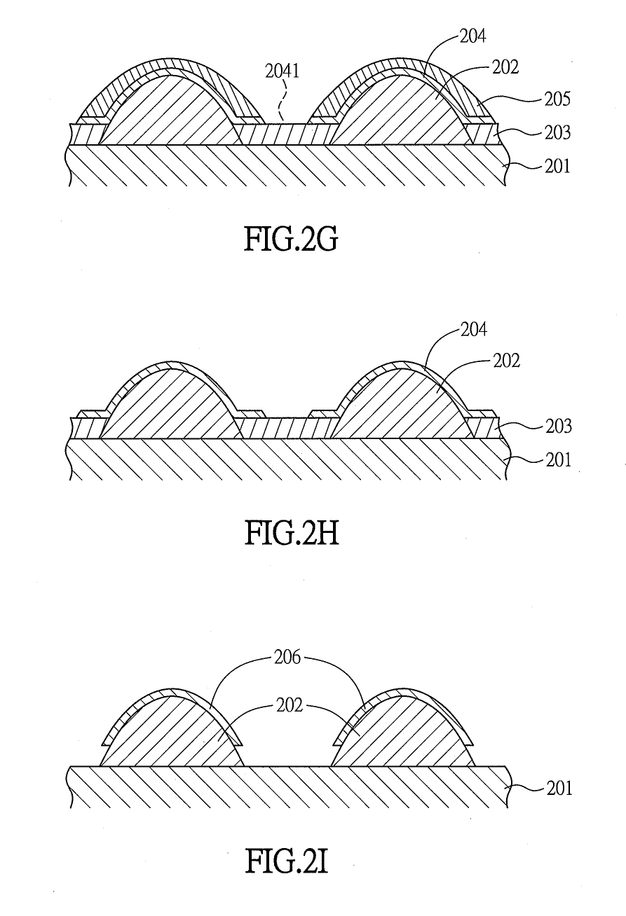

FIG. 1 is a flow chart of an electrode manufacturing method of a blue phase liquid crystal (BPLC) display panel according to an embodiment of the invention, and FIGS. 2A to 2I are schematic diagrams showing the electrode manufacturing method of a BPLC display panel according to the first embodiment of the invention. The electrode manufacturing method is illustrated as below by referring to FIG. 1 and FIGS. 2A to 2I.

As shown in FIG. 2A, the step S11 is to form a plurality of protrusions 202 on a substrate 201. FIG. 2A shows a sectional structure of the protrusion 202. In this embodiment, the form of the protrusion 202 is not limited, which can include a flat surface, a curviform surface, a polygon, or their any combination, for example. Herein, the section of the protrusion 202 is instanced as curviform. The substrate 201 can be a top substrate or a bottom substrate of the BPLC display panel. The top substrate can be a color filter (CF) substrate while the bottom substrate is a thin film transistor (TFT) substrate, for example. Otherwise, the substrate an be a COA (color filter on array, i.e. the CF layer is disposed on a side the same as the TFT array) substrate, a BOA (BM on array, i.e. the black matrix (BM) layer is disposed on a side the same as the TFT array) substrate, or a TOC (TFT on CF, also called “array on CF”, i.e. the TFT array is disposed on the CF substrate) substrate. The protrusion 202 can be formed by the process of development, imprinting, injection or etching, for example.

Then, as shown in FIGS. 2B and 2C, the step S12 is to form a first patterned photoresist layer 203 covering the protrusions 202 and the substrate 201 and exposing a part of each of the protrusions 202. Herein, the first patterned photoresist layer 203 is formed by exposure development, and the exposed part is the top portion of the protrusion 202. In FIG. 2B, a photoresist layer (negative photoresist for example) 2031 is first formed, and then the exposure through a photomask 2032 and the development are sequentially performed for forming the first patterned photoresist layer 203 as shown in FIG. 2C. To be noted, the exposed part of the protrusion 202 will determine the covered range of the protrusion 202 by the driving electrode (such as a pixel electrode or a common electrode) that is formed later and the height between the driving electrode and the substrate 201.

Then, as shown in FIG. 2D, the step S13 is to form a driving electrode layer 204 covering the first patterned photoresist layer 203 and the protrusions 202.

Then, as shown in FIGS. 2E and 2F, the step S14 is to form a second patterned photoresist layer 205 covering the driving electrode layer 204 and exposing at least an electrode exposing portion 2041 of the driving electrode layer 204 located between two protrusions 202. In FIG. 2E, a photoresist layer (negative photoresist for example) 2051 is first formed, and then the exposure through a photomask 2052 and the development are sequentially performed for forming the second patterned photoresist layer 205 as shown in FIG. 2F. In this embodiment, the first and second patterned photoresist layers 203 and 205 can both be positive photoresist or negative photoresist, and herein they are instanced as negative photoresist. Because the first patterned photoresist layer 203 exists over the area between the bottom portions of the protrusions, the peak-to-valley height of the protrusion 202 is reduced when the photoresist layer 2051 is disposed thereon, so that the photoresist layer 2051 can be formed uniformly. Thereby, the second patterned photoresist layer 205 can be formed more accurately, and that means the electrode exposing portion 2041 can be exposed accurately and the second patterned photoresist layer 205 can accurately cover the top portion of the protrusion 202.

Then, as shown in FIG. 2G, the step S15 is to remove the electrode exposing portion 2041. Since the electrode exposing portion 2041 is not protected by the photoresist layer, it can be removed by etching for example.

Then, as shown in FIG. 2H, the step S16 is to remove the second patterned photoresist layer 205. The second patterned photoresist layer 205 can be removed by an organic solution for example.

Then, as shown in FIG. 2I, the step S17 is to remove the first patterned photoresist layer 203 for defining a plurality of driving electrodes 206 from the driving electrode layer 204. The driving electrodes 206 can be pixel electrodes or common electrodes, or can be their combination,

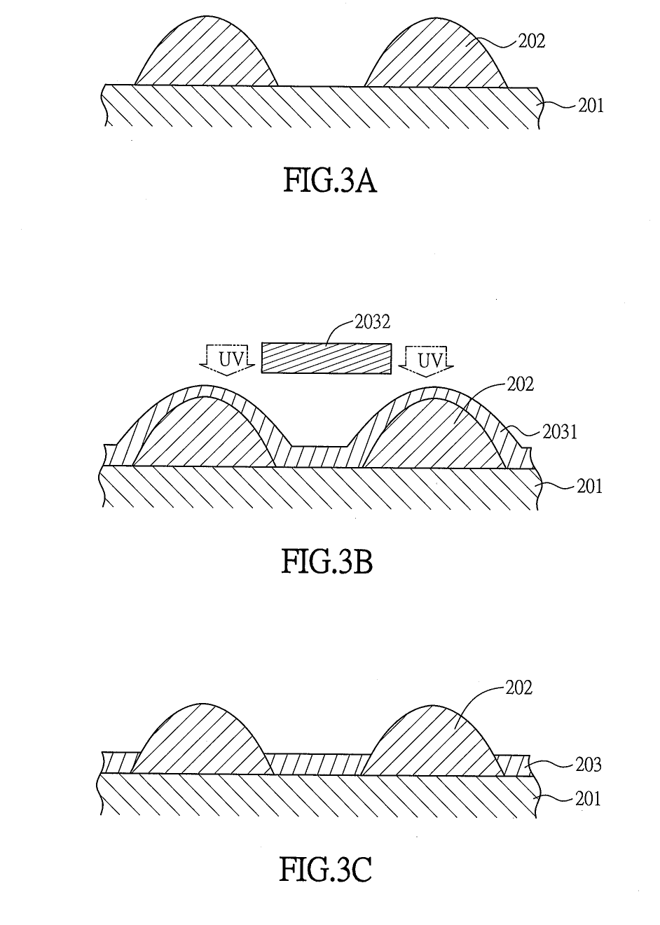

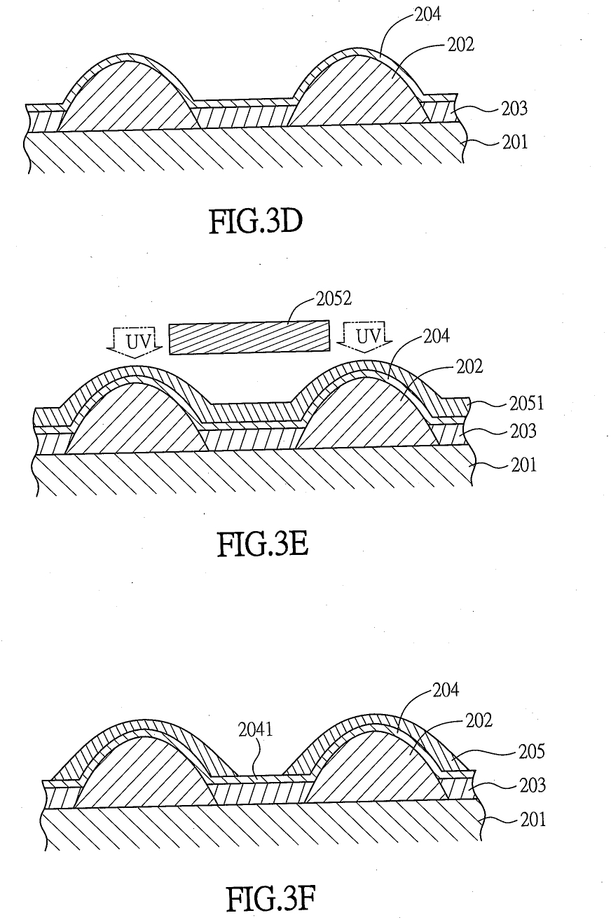

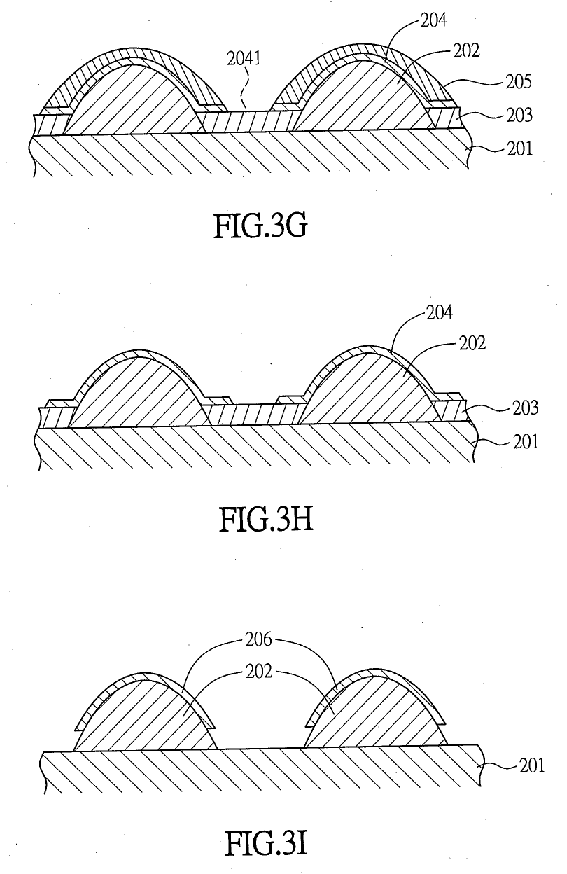

FIGS. 3A to 3I are schematic diagrams showing the electrode manufacturing method of a BPLC display panel according to the second embodiment of the invention. Different from the above first embodiment, the first patterned photoresist layer 203 and the second patterned photoresist layer 205 of this embodiment are the combination of positive photoresist and negative photoresist, and herein the first patterned photoresist layer 203 is positive photoresist while the second patterned photoresist layer 205 is negative photoresist for example. Thereby, the photomasks 2032 and 2052 of this embodiment can be the same so that the number of the required photomask can be decreased.

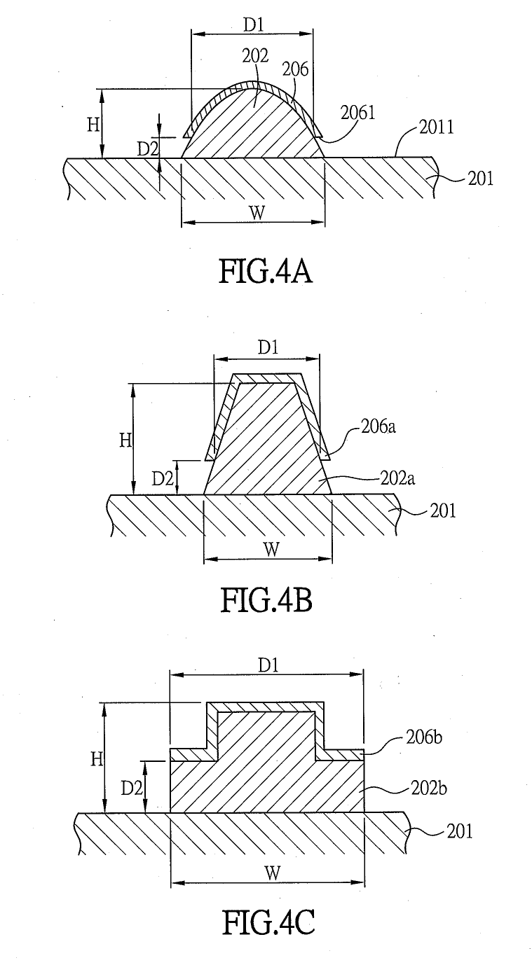

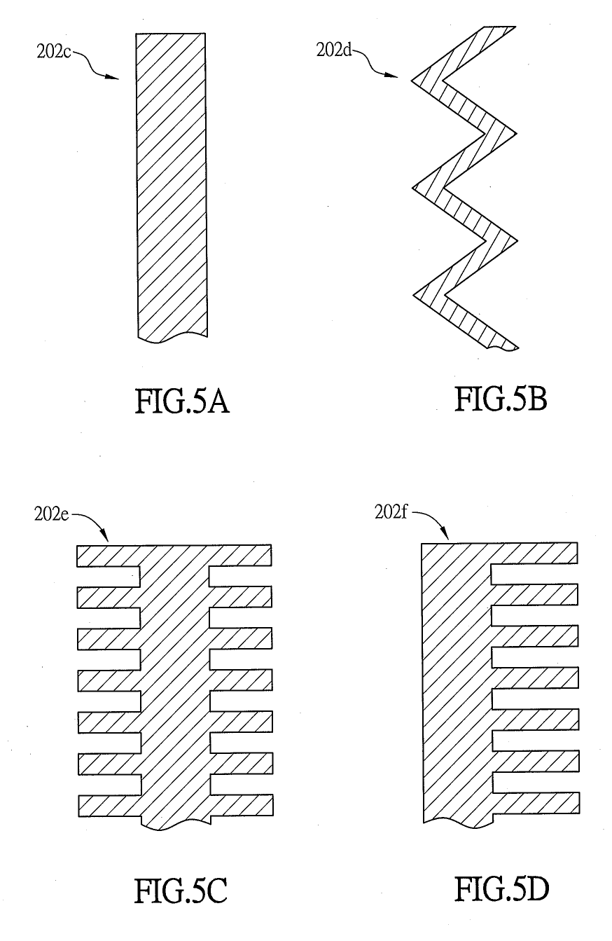

FIG. 4A is an enlarged diagram of the substrate 201, one of the protrusions 202, and the corresponding driving electrode 206 in FIG. 2I. As shown in FIG. 4A, by the electrode manufacturing method of the embodiments, the driving electrode 206 covers the protrusion 202 instead of contacting a surface 2011 of the substrate 201, no driving electrode 206 remains between two protrusions 202, and the driving electrode 206 on the top portion of the protrusion 202 is not broken completely for maintaining the completeness of the electrical conductivity. For an optimized condition, a horizontal distance D1 projected on the substrate of two end portions (specifically indicating the point contacting the protrusion) 2061 of the driving electrode 206 is less than or equal to a bottom width (such as the distance for which the protrusion contacts the substrate) W of the protrusion 202, and greater than or equal to a half of the bottom width W. For another optimized condition, a vertical distance D2 from one of the end portions 2061 of the driving electrode 206 to the surface 2011 of the substrate 201 is larger than zero, and less than or equal to four fifths of the height H of the protrusion 202. Preferably, the vertical distance D2 is greater than or equal to one fifth of the height H of the protrusion 202, and less than or equal to four fifths of the height H of the protrusion 202. Any of the above conditions can be established individually or collectively according to the practical requirements, such as concerning the cooperation of the protrusion's form and the driving electrode.

The protrusion of the embodiments of the invention can have many variations, some of which are shown by FIGS. 4B and 4C for example. In FIG. 4B, the protrusion 202a is a trapezoid, and the driving electrode 206a covers the protrusion 202a in conformity with the optimized condition of the horizontal distance D1 or the vertical distance D2. In FIG. 4C, the protrusion 202b is a stepped form, and the driving electrode 206b covers the protrusion 202b in conformity with the optimized condition of the vertical distance D2.

Besides, the protrusion of the embodiments of the invention can have many variations in a top view, some of which are illustrated as below for example. In FIGS. 5A to 5D, the protrusions 202c˜202f are bar-shaped, jagged, grid-shaped, and pectinate, respectively.

The embodiments of the invention also disclose a BPLC display panel, and it can have any of the protrusions and any of the driving electrodes mentioned in the all forgoing embodiments. The BPLC display panel is illustrated as below for example.

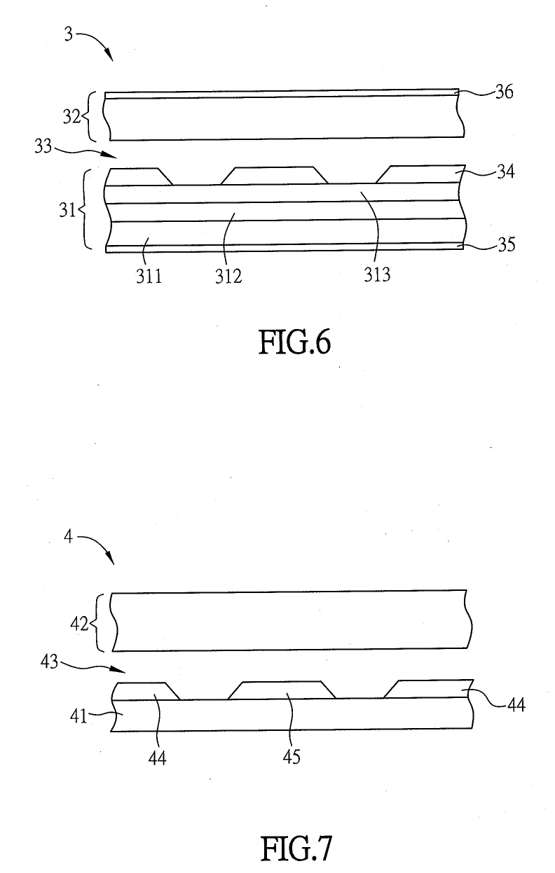

As shown in FIG. 6, a BPLC display panel 3 includes a first substrate 31, a second substrate 32, and a BPLC 33 disposed between the first and second substrates 31 and 32. Herein, the first substrate 31 includes a transparent plate 311, a common electrode layer 312, and an insulating layer 313. The BPLC display panel 3 further includes a plurality of protrusions 34 and a plurality of driving electrodes (not shown) respectively covering the protrusions 34. The form of the protrusion 34 in FIG. 6 is just for example, and actually the protrusion 34 and the corresponding driving electrode can be any of the structures of the protrusions and driving electrodes mentioned in the foregoing embodiments. The protrusion 34 is disposed on a surface of the first substrate 31 and towards the second substrate 32. Herein, the protrusion 34 is formed on a surface of the insulating layer 313 of the first substrate 31. The common electrode layer 312 functions as another driving electrode, electrically insulated from the driving electrode on the protrusion 34 by the insulating layer 313. In other words, the common electrode layer 312 and the driving electrode on the protrusion 34 are both disposed on the first substrate 31 but not disposed on the same plane. Herein, the driving electrode disposed on the protrusion 34 is a pixel electrode. To be noted, in other embodiments, the common electrode layer 312 can be changed into a pixel electrode while the driving electrode disposed on the protrusion 34 is changed into a common electrode. Moreover, the BPLC display panel 3 further includes a first polarizing element 35 and a second polarizing element 36. The first polarizing element 35 is disposed on the first substrate 31 while the second polarizing element 36 is disposed on the second substrate 32, and they can both be polarizing plates or polarizing films for example. The BPLC display panel in FIG. 6 is a fringe field switching (FFS) liquid crystal display panel for example. Moreover, the first substrate 31 can include other required elements, such as data lines, scan lines, TFTs, etc. These elements are used for driving the pixel electrodes of the pixels of the BPLC display panel 3. Besides, if the first substrate 31 is a COA substrate, it will have a CF layer, and if the first substrate 31 is a BOA substrate, it will have a black matrix layer. The second substrate 32 also can include other required elements, such as a CF layer, a BM layer, etc.

As shown in FIG. 7, a BPLC display panel 4 includes a first substrate 41, a second substrate 42, and a BPLC 43 disposed between the first and second substrates 41 and 42. The BPLC display panel 4 can further include polarizing elements (not shown). The BPLC display panel 4 further includes a plurality of protrusions 44 and 45 and a plurality of driving electrodes (not shown) respectively covering the protrusions 44 and 45. The form of the protrusions 44 and 45 in FIG. 7 is just for example, and actually the protrusions 44 and 45 and the corresponding driving electrodes thereon can be any of the structures of the protrusions and driving electrodes mentioned in the foregoing embodiments. The protrusions 44 and 45 are disposed on a surface of the first substrate 41 and towards the second substrate 42. Herein, the driving electrode disposed on the protrusion 44 functions as a common electrode while the driving electrode disposed on the protrusion 45 functions as a pixel electrode. To be noted, in other embodiments, the driving electrode disposed on the protrusion 44 can be changed into a pixel electrode while the driving electrode disposed on the protrusion 45 is changed into a common electrode. In other words, the driving electrodes on the protrusions 44 and 45 are the combination of the pixel electrode and the common electrode, and the pixel electrode and the common electrode are disposed alternately. The BPLC display panel in FIG. 7 is an in-plane switching (IPS) liquid crystal display panel for example. Moreover, the first substrate 41 can include other required elements, such as data lines, scan lines, TFTs, etc. These elements are used for driving the pixel electrodes of the pixels of the BPLC display panel 4. Besides, if the first substrate 41 is a COA substrate, it will have a CF layer, and if the first substrate 41 is a BOA substrate, it will have a black matrix layer. The second substrate 42 also can include other required elements, such as a CF layer, a BM layer, etc.

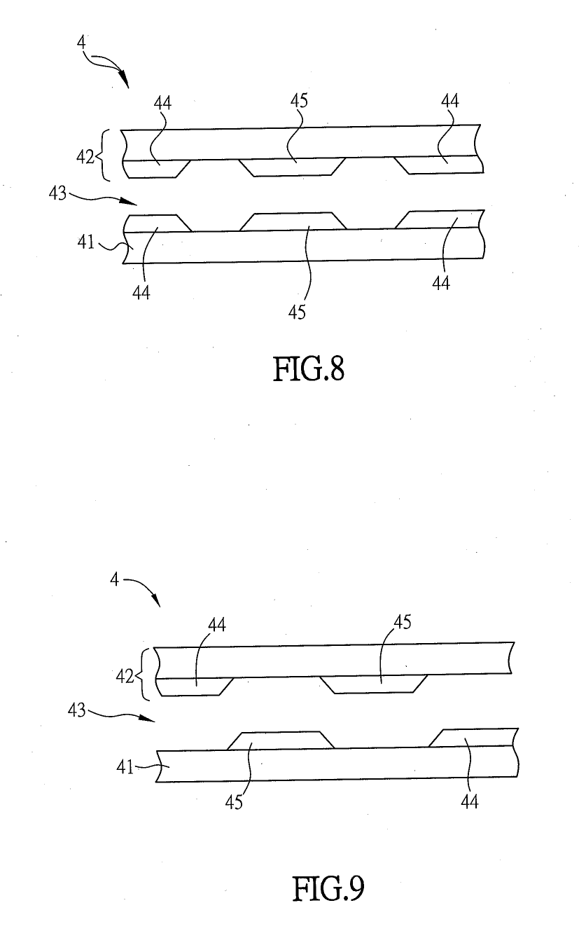

FIG. 8 is a schematic diagram of a variation of the BPLC display panel 4. In FIG. 8, the protrusions 44 and 45 are further disposed on a surface of the second substrate 42 and towards the first substrate 41, and the corresponding driving electrodes further cover the protrusions 44 and 45 of the second substrate 42. Herein, the BPLC display panel 4 in FIG. 8 is a double-sided in-plane switching (IPS) liquid crystal display panel.

FIG. 9 is a schematic diagram of another variation of the BPLC display panel 4. In FIG. 9, the protrusions 44 and 45 disposed on the first substrate 41 and those disposed on the second substrate 42 are staggered with each other. The BPLC display panel 4 in FIG. 9 is a double-sided in-plane switching (IPS) liquid crystal display panel with the staggered driving electrodes on the protrusions.

In summary, in the BPLC display panel and the electrode manufacturing method thereof according to the embodiments of the invention, a first patterned photoresist layer is first formed to cover a part of the protrusions and the substrate so that the peak-to-valley height of the protrusion is reduced when the photoresist layer is disposed thereon. Thereby, the second patterned photoresist layer can be formed more uniformly and accurately, and therefore the second patterned photoresist layer will not remain at the electrode exposing portion so that the electrode exposing portion can be removed completely and accurately. Besides, the second patterned photoresist layer can completely and accurately cover the top portion of the protrusion to protect the driving electrode on the top portion of the protrusion from being removed in the step of removing the electrode exposing portion, for maintaining the completeness of the electrical conductivity. Furthermore, the driving electrode of the embodiments of the invention can be applied to various types of display panels, such as IPS, FFS, double-sided IPS with symmetrical driving electrodes on protrusions, double-sided FFS with symmetrical driving electrodes on protrusions, double-sided IPS with staggered driving electrodes on protrusions, double-sided FFS with staggered driving electrodes on protrusions. Therefore, the BPLC display panel and the electrode manufacturing method thereof according to the embodiments of the invention can increase the production yield a lot.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A blue phase liquid crystal (BPLC) display panel, comprising:
a first substrate;
a second substrate;
a protrusion disposed on the first substrate;
a BPLC disposed between the first and second substrates; and
a driving electrode covering the protrusion, wherein a vertical distance from one end portion of the driving electrode to a bottom of the protrusion is larger than zero, and less than or equal to four fifths of a height of the protrusion.

2. The BPLC display panel as recited in claim 1, wherein the vertical distance is greater than or equal to one fifth of the height of the protrusion.

3. The BPLC display panel as recited in claim 1, wherein a horizontal distance of two end portions of the driving electrode is less than or equal to a width of the bottom of the protrusion, and greater than or equal to a half of the width.

4. The BPLC display panel as recited in claim 1, wherein the first substrate is a top substrate or a bottom substrate of the BPLC display panel.

5. The BPLC display panel as recited in claim 1, wherein the form of the protrusion includes a flat surface, a curviform surface, a polygon, or their any combination.

6. The BPLC display panel as recited in claim 1, wherein the driving electrode is a pixel electrode.

7. The BPLC display panel as recited in claim 1, wherein the driving electrode is a common electrode.

8. The BPLC display panel as recited in claim 1, further comprising:
a protrusion disposed on the second substrate; and
a driving electrode covering the protrusion of the second substrate.

9. The BPLC display panel as recited in claim 8, wherein the driving electrodes disposed on both of the first and second substrates are the combination of a pixel electrode and a common electrode.

10. The BPLC display panel as recited in claim 1, further comprising:
another driving electrode disposed on the first substrate; and
an insulating layer disposed between the another driving electrode and the driving electrodes.

11. The BPLC display panel as recited in claim 1, wherein the shape of the protrusion is bar-shaped, jagged, grid-shaped, and pectinate.

12. The BPLC display panel as recited in claim 1, further comprising:
a first polarizing element disposed on the first substrate; and
a second polarizing element disposed on the second substrate.

13. A blue phase liquid crystal (BPLC) display panel, comprising:
a first substrate;
a second substrate;
a protrusion disposed on the first substrate;
a BPLC disposed between the first and second substrates; and
a driving electrode covering the protrusion, wherein a horizontal distance of two end portions of the driving electrode is less than or equal to a width of a bottom of the protrusion, and greater than or equal to a half of the width.

14. An electrode manufacturing method of a blue phase liquid crystal (BPLC) display panel, comprising steps of:
forming a plurality of protrusions on a substrate;
forming a first patterned photoresist layer covering the protrusions and the substrate and exposing a part of each of the protrusions;
forming a driving electrode layer covering the first patterned photoresist layer and the protrusions;
forming a second patterned photoresist layer covering the driving electrode layer and exposing at least an electrode exposing portion of the driving electrode layer located between the protrusions;
removing the electrode exposing portion;
removing the second patterned photoresist layer; and
removing the first patterned photoresist layer for defining a plurality of driving electrodes from the driving electrode layer.

15. The electrode manufacturing method as recited in claim 14, wherein the first patterned photoresist layer and the second patterned photoresist layer are both positive photoresist or negative photoresist.

16. The electrode manufacturing method as recited in claim 14, wherein the first patterned photoresist layer and the second patterned photoresist layer are the combination of positive photoresist and negative photoresist.

17. The electrode manufacturing method as recited in claim 14, wherein the driving electrodes are pixel electrodes.

18. The electrode manufacturing method as recited in claim 14, wherein the driving electrodes are common electrodes.

19. The electrode manufacturing method as recited in claim 14, wherein the driving electrodes are the combination of pixel electrodes and common electrodes.

20. The electrode manufacturing method as recited in claim 14, wherein the exposed part of each of the protrusions is a top portion of the protrusion.
